(19) United States
(12) Patent Application Publication
(10) Pub. No.: US 2016/0316501 A1
(43) Pub. Date: Oct. 27, 2016

(54) DEVICE PAIRING

(71) Applicant: INTEL CORPORATION, Santa Clara, CA (US)

(72) Inventors: Bryan Roe, Camas, WA (US); Nithyananda Jeganathan, Portland, OR (US)

(73) Assignee: Intel Corporation, Santa Clara, CA (US)

(21) Appl. No.: 15/101,340

(22) PCT Filed: Dec. 26, 2013
(86) PCT No.: PCT/US2013/077760

§ 371 Date: Jun. 2, 2016

(51) Int. Cl. H04W 76/02; H04W 12/08

(52) U.S. Cl. CPC H04W 76/023; H04W 76/021; H04W 12/08

(57) ABSTRACT

Aspects of the disclosure permit pairing of wireless computing devices. In one aspect, the wireless computing device include a first wireless device and a second wireless device, where the pairing includes a pre-pairing stage in which the devices to be paired can be validated and identity information associated with at least one of such devices is communicated. In another aspect, information associated with a supported pairing mechanism available for pairing the first wireless device and the second wireless device can be communicated. In yet an-other aspect, in response to completion of the pre-pairing stage, the first wireless device and the second wireless device can be functionally coupled based at least on the supported pairing mechanism.

### BACKGROUND

Conventional approaches or mechanisms to pairing of wireless devices, such as a wireless display adapter and a host device, generally provide rather polarized end-user experiences—typically, one such experience either entails direct user intervention or mitigates user intervention at the expense of inadequate or likely compromised security of the pairing mechanism. Even pairing mechanisms contemplating substantive end-user intervention generally are prone to pairing inaccuracies or other inadequacies.

### BRIEF DESCRIPTION OF THE DRAWINGS

The accompanying drawings form an integral part of the disclosure and are incorporated into the present specification. The drawings illustrate example embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as limited to the implementations set forth herein. Like numbers refer to like elements throughout.

FIG. 1 illustrates an example operational environment in accordance with one or more aspects of the disclosure.

FIGS. 2A-2B present examples of computing devices in accordance with one or more aspects of the disclosure.

FIG. 3-6 present examples of pairing techniques in accordance with one or more aspects of the disclosure.

### DETAILED DESCRIPTION

The disclosure recognizes and addresses, in one aspect, the issue of inaccurate and/or involved end-user intervention in pairing mechanisms for wireless computing devices. The disclosure provides devices, systems, techniques, and/or computer program products that can permit operational pairing of wireless computing devices. As described in greater detail below, in one aspect, pairing of a first wireless computing device and a second wireless computing device can include a pre-pairing stage in which such wireless devices can be validated and identity information associated with at least one of the first wireless device or the second wireless device can be communicated between such wireless devices. Validation of at least one device of such wireless devices can include configuration of a pairing object including information representative of the at least one wireless device. In addition, at least a portion of the identity information can include information indicative of an intended relationship (e.g., functional coupling) between the first wireless device and the second wireless device. In another aspect, information associated with a supported pairing mechanism available for pairing the first wireless device and the second wireless device can be communicated between such devices. In yet another aspect, in response to completion of the pre-pairing stage, the first wireless device and the second wireless device can be functionally coupled based at least on the supported pairing mechanism.

Embodiments of the disclosure can provide various advantages over conventional technologies for pairing of devices, such as wireless computing devices. One example advantage may include simplification of end-user intervention related to associating a wireless device to a host device, including mitigation or avoidance of reliance on end-user credentials and/or user-interaction (such as pressing a button) for implementation of device pairing. Another example advantage may include judicious discrimination of end-users that are permitted to pair devices. In contrast to simplified conventional pairing mechanisms (such as “push button” pairing without an actual button to actuate), embodiments of the disclosure mitigate or avoid scenarios in which end-user pairs the end-user's device to a device of a second end-user, without knowledge or consent of the second end-user. At least certain embodiments of the disclosure can permit (exclusively, for example) a specific end-user to readily pair devices without reliance on a burdensome pairing mechanism. Yet another advantage may include reduction or avoidance of pairing inaccuracies that may lead to troubleshooting difficulties or non-operational pairing configurations. Examples of pairing inaccuracies that can be mitigated include end-users or operators accidentally selecting an incorrect device to pair with because they were unable to differentiate multiple devices from each other.

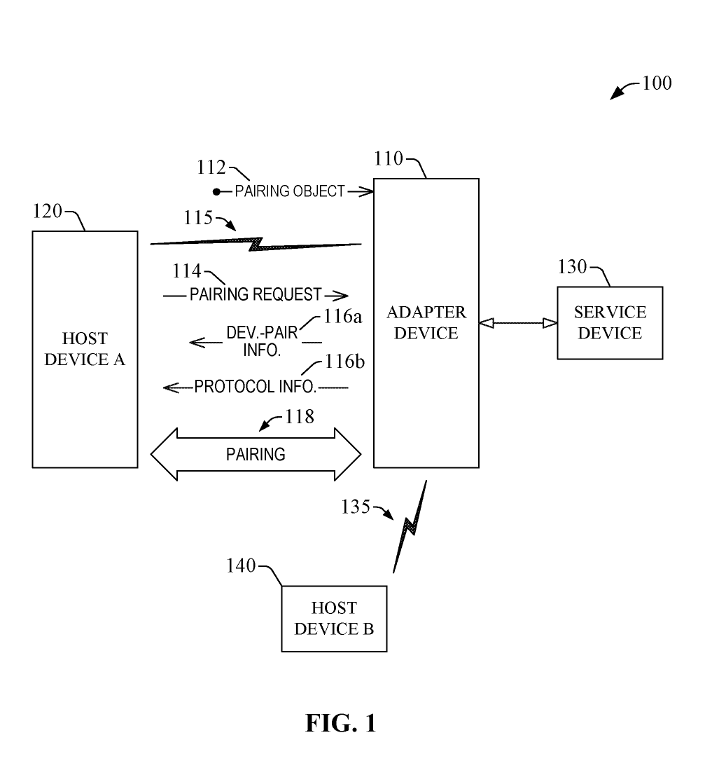

With reference to the drawings, FIG. 1 illustrates an example of an operational environment 100 that permits pairing of computing devices in accordance with at least certain aspects of the disclosure. The computing devices contemplated in the present disclosure include electronic devices having computational resources, including processing resources (e.g., processor(s)), memory resources (memory devices (also referred to as memory), and communication resources for exchange of information within the computing device and/or with other computing devices. Such resources can have different levels of architectural complexity depending on specific device functionality. Exchange of information among computing devices in accordance with aspects of the disclosure can performed wirelessly as described herein. Example of computing devices contemplated in the present disclosure include desktop computers; mobile computers, such as tablet computers, smartphones, notebook computers, laptop computers with wireless communication resources, Ultrabook™ computers; gaming consoles, mobile telephones; a blade computers; programmable logic controllers; near field communication devices; customer premises equipment, such a set-top boxes, wireless routers, wireless-enabled television sets, or the like; and so forth.

The operational environment 100 can include an adapter computing device 110 (which also may be referred to as “adapter device 110”) that can include a pairing object 112 comprising a unique identifier associated with (e.g., indicative or otherwise representative of) a computing device that can be functionally paired to the adapter device 110. Such a computing device may be referred to as a host device. The unique identifier can be embodied in or can comprise a logical address or a physical address (e.g., a media access control (MAC) address). It should be appreciated that, in one aspect, other information structure(s) can be utilized or leveraged to convey unique identifiers associated with computing devices that can operate as host devices.

The pairing object 112 can be provided to the adapter device 110 statically or dynamically (e.g., in response to a certain event). In an implementation in which the pairing object is provided statically, the pairing object 112 or a portion thereof can be encoded into the adapter device 110 at a manufacturing stage of such a device. For instance, a unique identifier (e.g., a MAC address) contained in the pairing object 112 can be encoded within non-volatile memory in the adapter device 110. In an implementation in which the paring object 112 is provided dynamically, the adapter device 110 can be functionally coupled (e.g., connected) to another computing device via a communication link, and in response, a unique identifier (e.g., a MAC address) associated with the computing device can be encoded within the adapter device 110. The communication link can be embodied in or can comprise a universal serial bus (USB) connector and/or other wireline or wireless connector. As part of such encoding, in one aspect, the pairing object 112 can be generated in memory within the adapter device 110 in order to contain the unique identifier. In another aspect, an extant pairing object 112 can be updated (e.g., rewritten or otherwise reconfigured in memory) in order to retain the unique identifier.

In the operational environment 100, a computing device 120 that can operate as a host device, and may be referred to as “host device A 120,” can be functionally coupled to (e.g., communicatively coupled with) the adapter device 110 via one or more links 115. The adapter device 110 can be functionally coupled to a service device 130 (e.g., a display unit or a device for consumption of information, such as digital media), and the computing device can utilize or leverage the service device 130 by functionally pairing itself with the adapter device 110. The functional coupling is represented with a double-ended arrow having open arrowheads. Such an arrow is intended to indicate that the adapter device 110 can be functionally coupled to the service device 130 via a link (e.g., a cable or wireless link) and/or other means for coupling, or can be functionally integrated into the service device 130 (e.g., by relying on suitable adapter(s) or interface(s) present in such adapter and device). To at least such an end, in one aspect, the host device A 120 can communicate a pairing request 114 to the adapter device 110. The pairing request 114 can include identification (ID) information that is representative or otherwise indicative of the host device A 120. For instance, the pairing request 114 can include a logical address, a physical address (such as a MAC address), other device identifier, or a combination thereof.

The adapter device 110 can receive the pairing request 114 and, in response, can determine if the ID information contained in the pairing request 114 matches the unique identifier (e.g., a MAC address) that is contained in the pairing object 112. To at least such an end, in one implementation, the adapter device 110 can compare the pairing object 112 that is configured in the adapter device 110 with at least a portion of the ID information contained in the pairing request 114. In response to such a comparison yielding a match between the ID information and the unique identifier, the adapter device 110 can authorize the pairing request 114 or can configure the pairing request 114 as permissible. In the alternative, in response to such a comparison yielding a mismatch between the ID information and the unique identifier, the adapter device 110 can decline the pairing request 114 or can configure the pairing request 114 as impermissible. A declined or impermissible pairing request 114 can cause the adapter device 110 to implement an exception.

In response to the pairing request 114 being authorized or otherwise configured as permissible, the adapter device 110 can communicate pairing information to the host device 120 via at least one of the link(s) 115. In one aspect, such link(s) 225 can include a downstream link (DL) and/or an upstream link (UL), and can be embodied in wired link(s), wireless link(s) (including terrestrial air interfaces and/or deep-space link(s)), or a combination thereof. The pairing information can include device-pair ID information 116a (which also may be referred to as “ID info. 116a”) that is indicative or otherwise representative of an intended relationship between a host device and an adapter device. For instance, the pairing information can include a string of characters specifying such relationship: “Host Device_A—Connect to present adapter.” Accordingly, in one aspect, it can be appreciated that the device-pair information 116a can be embodied or can comprise a directive to pair or otherwise associate the adapter device 110 with the host device A 120. In certain implementations, the adapter device 110 can configure or otherwise customize an advertised or otherwise broadcasted identifier thereof in order to communicate (e.g., advertise or broadcast) the customized advertised identifier within the device-pair information 116a. Communication of such device-pair information 116a (which also may be referred to as dev.-pair info. 116a) can permit making an end-user of the host device A 120 explicitly aware that the adapter device 110 is the intended or desired device for pairing.

In addition or in the alternative, the pairing information that is communicated (e.g., advertised or broadcasted) by the adapter device 110 in response to an authorized pairing request 114 can include protocol-support information 116b (which also may be referred to as “protocol info. 116b”) indicative or otherwise representative of one or more pairing protocols that can be supported for pairing the adapter device 110 and the host device A 120. The one or more pairing protocols can include at least one pairing protocol, such as push-button pairing, that need not rely on end-user intervention in order to be effected. Accordingly, it can be appreciated that communication of the protocol info. 116b can permit an end-user of the host device A 110 to pair such a device with the adapter device 110 without input of pairing information, such as security credentials (e.g., personal identification numbers (PINs), passwords, combinations thereof, or the like), and/or without consumption of other pairing information, such as special pages or pairing data

Communication of pairing information as described herein can permit implementation of a pairing protocol, which is represented as a pairing 118 in FIG. 1, between the host device A 120 and the adapter device 110. In certain scenarios, such a pairing protocol (e.g., push-button pairing) can be conveyed or otherwise identified in the protocol info.116b, and can exclude end-user intervention.

It can be appreciated that configuration of the adapter device 110 with the pairing object 112, and authorization of the pairing request 114 can permit exchange of information that can permit accurate and secure functional pairing between the adapter device 110 and the host device A 120. In contrast, for another computing device 140 (which may be referred to as host device B 140) having a unique identifier (e.g., a MAC address) that is mismatched with the pairing object 112 or information contained therein (such as a second MAC address), a pairing request originating from the host device B 140 may be unauthorized. As a result, in one aspect, the adapter device 110 can withhold the pairing information described herein (e.g., device-pair info. 116a and/or protocol info. 116b), and functional pairing of the host device B 140 and the adapter device 110 can be implemented in accordance with a predetermined pairing protocol. Withholding of the pairing information can cause the host device B 140 to present or otherwise render the adapter device 110 as if it were a generic adapter device rather than a specific adapter intended or otherwise preferred for pairing with the host device B 140. In addition, such an implementation can provide a conventional interaction between an end-user of the host device B 140 and the terminal adapter 110. Accordingly, in one aspect, pairing of the host device B 140 and the adapter device 110 may not proceed without physical access of an end-user to the adapter device 110.

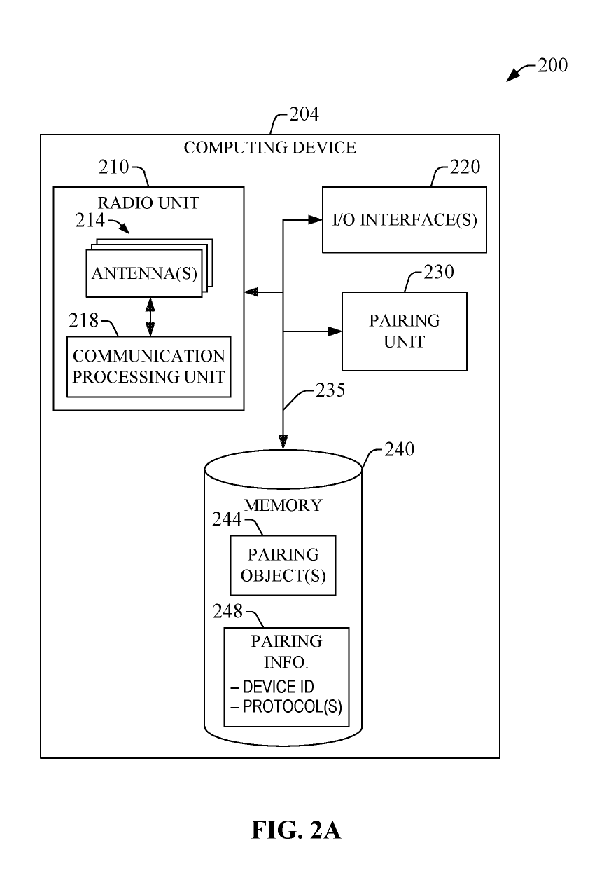

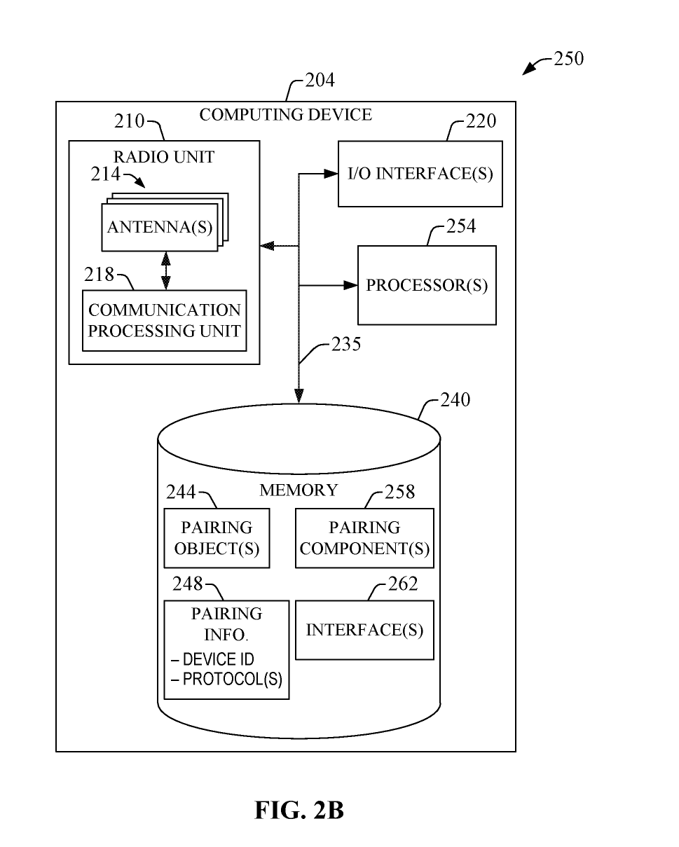

FIG. 2A illustrates a block diagram of an example embodiment 200 of a computing device 204 in accordance with one or more aspects of the disclosure. The computing device 204 can embody or can comprise the adapter device 110 described herein. As illustrated, the computing device 204 can include a radio unit 210 that can permit wireless communication between the computing device and another computing device, such as one of the host device A 120 or the host device B 140. To at least such an end, in one aspect, the radio unit 210 can include one or more antennas 214 that can receive and/or transmit wireless signals (e.g., electromagnetic radiation). The radio unit 210 also can include a communication processing unit 218 that can process at least such signals in accordance with one or more radio technology protocols and/or modalities (such as multiple-input-multiple-output (MIMO), single-input-multiple-output (SIMO), multiple-input-single-output (MISO), and the like. Each of such protocol(s) can be configured to communicate (e.g., transmit, receive, or exchange) data, metadata, and/or signaling over a specific air interface. The radio technology protocol(s) can include 3^{rd} Generation Partnership Project (3GPP) Universal Mobile Telecommunication System (UMTS); 3GPP Long Term Evolution (LTE); LTE Advanced (LTE-A); Wi-Fi protocols, such as those of the Institute of Electrical and Electronics Engineers (IEEE) 802.11 family of standards;

Worldwide Interoperability for Microwave Access (WiMAX); radio technologies and related protocols for ad hoc networks, such as Bluetooth or ZigBee; other protocols for packetized wireless communication; or the like). The communication processing unit 218 also can process non-wireless signals (analogic, digital, optical, a combination thereof, or the like).

The radio unit 210 can permit the computing device 204 to operate in a variety of wireless environments having wireless signals conveyed in different electromagnetic radiation frequency bands. To at least such end, in one aspect, the communication processing unit 218 can process (code, decode, format, etc.) wireless signals within a set of one or more electromagnetic (EM) frequency bands comprising one or more of radio frequency (RF) portions of the EM spectrum, microwave portion(s) of the EM spectrum, or infrared (IR) portion(s) of the EM spectrum. In one aspect, the set of one or more frequency bands can include at least one of (i) all or most licensed EM frequency bands (such as the industrial, scientific, and medical (ISM) bands, including the 2.4 GHz band or the 5 GHz bands); or (ii) all or most unlicensed frequency bands (such as the 60 GHz band) currently available for telecommunication. To process wireless signal in such frequency bands, the communication processing unit 218 can include a set of one or more transmitters/receivers, and components therein (e.g., amplifiers, filters, analog-to-digital (A/D) converters, etc.), functionally coupled to a multiplexer/demultiplexer (mux/demux) unit, a modulator/demodulator (mod/demod) unit (also referred to as “modem”), and a coder/decoder unit (also referred to as codec). Each of the transmitter(s)/receiver(s) can form respective transceiver(s) that can transmit and receive wireless signals via the antenna(s) 214. In one implementation, each of the receiver(s) can operate as a tuner, collecting wireless signals in at least one of the EM frequency bands.

Each of the one or more transmitters/receivers can convert a signal from analog to digital and vice versa. In addition or in the alternative, the transmitter(s)/receiver(s) can divide a single data stream into multiple parallel data streams, or perform the reciprocal operation. Such operations may be conducted as part of various multiplexing schemes. As illustrated, the mux/demux unit 508 is functionally coupled to the one or more transmitters/receivers 504 and can permit processing of signals in time and frequency domain. In one aspect, the mux/demux unit 508 can multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), and/or space division multiplexing (SDM). In addition or in the alternative, in another aspect, the mux/demux unit 508 can scramble and spread information (e.g., codes) according to most any code, such as Hadamard-Walsh codes, Baker codes, Kasami codes, polyphase codes, and the like. The modem 516 can modulate and demodulate information (e.g., data, metadata, and/or signaling) according to various modulation techniques, such as frequency modulation (e.g., frequency-shift keying), amplitude modulation (e.g., M-ary quadrature amplitude modulation (QAM), with M a positive integer; amplitude-shift keying (ASK)); phase-shift keying (PSK); and the like). In addition, the processor(s) 414 can permit or otherwise facilitate the host device 410 to process data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec referred to herein can operate on information (e.g., data, metadata, and/or signaling) in accordance with one or more coding/decoding schemes suitable for communication, at least in part, through the one or more transceivers formed from respective transmitter(s)/receiver(s). In one aspect, such coding/decoding schemes, or related procedure(s), can be retained as a group of one or more computer-accessible instructions (computer-readable instructions, computer-executable instructions, or a combination thereof) in memory 442. In a scenario in which wireless communication among the computing device 204 and another computing device, e.g., host device A 120, utilizes or otherwise leverages MIMO, MISO, SIMO, or SISO operation, the codec can implement at least one of space-time block coding (STBC) and associated decoding, or space-frequency block coding (SFBC) and associated decoding. In addition or in the alternative, the codec 512 can extract or otherwise acquire information from data streams coded in accordance with spatial multiplexing scheme. In one aspect, at least to decode received information (e.g., data, metadata, and/or signaling), the codec can implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec can utilize or otherwise leverage a mux/demux unit and/or a modem to operate in accordance with aspects described herein.

Electronic components and associated circuitry (e.g., the mux/demux, the codec, and modem referred to herein) contained in the communication processing unit 218 can permit or otherwise facilitate processing, e.g., coding/decoding, deciphering, and/or modulation/demodulation, of wireless signal(s) received by the computing device 204 and wireless signal(s) to be transmitted by the same. In one aspect, received and/or transmitted wireless signals can be modulated and/or coded, or otherwise processed, in accordance with one or more of radio technology protocols.

In certain embodiments, depending on intended or desired complexity, the computing device 204 can include multimode circuitry that can permit the radio unit 210 to operate in multiple communication modes through various terrestrial radio network technologies or deep-space satellite-based communication in accordance with disparate technical specifications (or standard protocols) for the radio network technologies or such a satellite communication. The terrestrial radio network technologies (e.g., second generation (2G), third generation (3G), fourth generation (4G)) can permit implementation of the radio technology protocols described herein. The multimode circuitry (e.g., one or more chipsets or “core(s)) can permit the radio unit 210 to operate in accordance with standard protocols specific to a telecommunication mode of operation, such as LTE-based communication, Wi-Fi-based communication, or point-to-point communication protocols. In another aspect, the multimode circuitry can be scheduled to operate concurrently in various modes or within a multitask paradigm in which the multimode circuitry can operate in a dedicated mode for a specific period.

The electronic components contained in the communication processing unit 218 can exchange information through a bus (not depicted in FIG. 2A), which can embody or can comprise at least one of a system bus, an address bus, a data bus, a message bus, a reference link or interface, a combination thereof, or the like. Such information can include data, metadata, code instructions, signaling and related payload data, combinations thereof, or the like.

As illustrated, the computing device also can include one or more input/output interfaces (which also may be referred to as “I/O interface(s) 220”) that can permit communication of information (e.g., data, metadata, and/or signaling) with other computing devices or entities, such as end-users or operators of the computing device 204. In certain scenarios, the I/O interface(s) 220 can include a group of connectors, such as one or more pins configured in accordance with various schemes and/or standards. The group of connectors can form part of a group of ports, which based on complexity, can comprise at least one of parallel ports, serial ports, Ethernet ports, V.35 ports, or X.21 ports, wherein parallel ports can comprise General Purpose Interface Bus (GPIB), IEEE-1284, while serial ports can include Recommended Standard (RS)-232, V.11, Universal Serial Bus (USB), FireWire or IEEE-1394 ports. In addition or in the alternative, at least one of the I/O interface(s) 220 can permit information input through a gesture or other forms of interaction with the computing device 204. Complexity of the gesture (e.g., touch, speech, movement) can be based on the degree complexity that may be afforded to the computing device 204. In certain embodiments, one of the I/O interface(s) 220 can be embodied in or can comprise a button that can be actuated as part of implementation of a pairing mechanism. In addition or in the alternative, the I/O interface(s) 220 can include one or more rendering units comprising one or more functional elements that can permit or otherwise facilitate control of the operation of the computing device 204, or can permit conveying or revealing operational conditions of the computing device 204. Depending on complexity, the one or more functional elements can include light(s), such as light-emitting diodes; a display, such as a liquid crystal display (LCD), a plasma monitor, a light emitting diode (LED) monitor, or an electrochromic monitor; combinations thereof; or the like.

At least one interface of the I/O interface(s) 220 can permit configuration of a pairing object (e.g., pairing object 112) in accordance with aspects of the disclosure. For instance, the at least one interface (e.g., a set of one or more pins or a USB connector) can permit access to information indicative of the pairing object, and can communicate or otherwise supply, e.g., via a bus architecture 235, at least a portion of such information to one or more memory devices 240 (herein referred to as “memory 240”). The pairing object can be retained within one or more memory elements 244 (herein referred to as “pairing object(s) 244”).

The computing device 204 can receive a pairing request (e.g., pairing request 114) wirelessly from another computing device (such as host device A 120; not depicted in FIG. 2A). Such a pairing request can be received wirelessly via the radio unit 210. In addition, in the illustrative embodiment 200, the computing device 204 can include a pairing unit 230 that can process the pairing request in accordance with aspects of the disclosure. In one aspect, the pairing unit 230 can determine if the pairing request is authorized. For instance, the pairing unit 230 can compare information contained within the pairing request with a pairing object retained within the memory 240 in the one or more memory elements 244. In another aspect, in response to ascertaining that the pairing request is authorized, the pairing unit 230 can provide or otherwise supply pairing information (e.g., dev.-pair info. 116a and protocol info. 116b) to the computing device that communicated such a pairing request. To at least such an end, in one implementation, the pairing unit 230 can generate at least a portion of the pairing information, and can communicate at least the portion of pairing information wirelessly to the computing device that originated the authorized pairing request. The pairing unit 230 can communicate such pairing information wirelessly via the radio unit 210. As illustrated, the memory 240 can contain one or more memory elements 248 (referred to as “pairing info. 248”) having information indicative or otherwise representative of intended or desired device-adapter pair(s) and/or information indicative of pairing protocol(s) that can be supported or can be utilized for functionally pairing the computing device 204 and the computing device that originated the authorized pairing request. As described herein, at least one of such pairing protocol(s) can be or can include a protocol that avoids end-user intervention in order to perform paring between devices.

In the illustrative embodiment 200, the bus architecture 235 (also termed “bus 235”) can couple functionally various elements of the computing device 204. The bus 235 can include at least one of a system bus, a memory bus, an address bus, or a message bus, and can permit exchange of information (data, metadata, and/or signaling) between at least two of the radio unit 210, the pairing unit 230, at least one of the I/O interface(s) 220, and the memory 530, or respective functional elements therein. In certain scenarios, the bus 235 in conjunction with one or more internal programming interfaces (such as application programming interfaces (APIs); not depicted in FIG. 2A) can permit such exchange of information.

In certain embodiments, such as embodiment 250 presented in FIG. 2B, the computing device 204 can include one or more processors 254 and one or more functional components (which may be referred to as “pairing component(s) 258) encoded or otherwise retained in the memory 240. In addition, in such an embodiment 250, one or more internal programming interfaces (referred to as “interface(s) 262”) also can be encoded or otherwise retained in the memory 240. The interface(s) 262 can embody or can include respective APIs that permit exchange of information (e.g., data, metadata, and/or signaling) among at least one of the pairing component(s) 258 and/or at least one of the processor(s) 254. At least a portion of at least one of the pairing component(s) 736 can program or otherwise configure one or more of the processor(s) 254 to operate at least in accordance with the functionality described herein. In one implementation, a combination of at least one processor of the processor(s) 254 and at least one of the pairing component(s) 258 can embody or can constitute the pairing unit 230 described herein. In another implementation, a combination of at least one processor of the processor(s) 254, at least one of the pairing component(s) 258, and at least one of the interface(s) 262 can embody or can constitute the pairing unit 230 described herein. In yet another implementation, at least one pairing component of the pairing component(s) 258 can include the pairing unit 230. In such implementations, the at least one processor of the processor(s) 258 can execute the at least one pairing component of the pairing component(s) 258 and/or can leverage the pairing object(s) 244 and/or the pairing information 248 in order to implement at least the functionality of the pairing unit 230 in accordance with one or more aspects of the disclosure. Accordingly, it can be appreciated that, in one aspect, at least the pairing component(s) 258 can render the computing device 204 (e.g., an adapter device, such as device 110) or any other computing device that contains such components a particular machine for providing a functional device pairing in accordance with aspects of the disclosure, among other functional purposes.

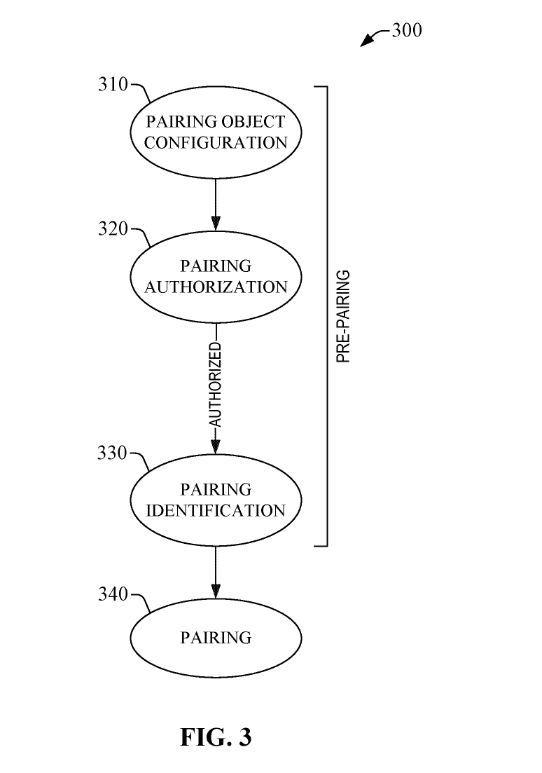

At least one component of the pairing component(s) 258 can be embodied in or can comprise one or more computer-accessible instructions, e.g., computer-readable and/or computer-executable instructions. In one scenario, in one aspect, at least a portion of the computer-accessible instructions can be executed to perform at least a part of one or more of the example methods described herein, such as the example methods presented in FIGS. 3-6. As described herein, in certain implementations, one or more of the processor(s) 254 can execute at least the portion of computer-accessible instructions. Execution of the one or more methods can permit implementation or performance of the functionality of the computing device 204 as an adapater device in accordance with aspects of the disclosure. For instance, as described herein, to embody one such method, at least a portion of the computer-accessible instructions can be persisted (e.g., stored, made available, or stored and made available) in a computer storage non-transitory medium and executed by a processor. The one or more computer-accessible instructions that embody at least one of pairing component(s) 254 can be assembled or otherwise arranged into one or more program modules that can be compiled, linked, and/or executed at the computing device 204 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 204 or functionally coupled thereto.

The computing device 204 can comprise a variety of computer-readable media. Computer-readable media can be any available media (transitory and non-transitory) that can be accessed by a computing device (e.g., the computing device 204 itself, or a host device, such as host device A 120). In one aspect, computer-readable media can comprise computer non-transitory storage media (or computer-readable non-transitory storage media) and communications media. Example computer-readable non-transitory storage media can be any available media that can be accessed by the computing device 204 or a functional element thereof or coupled thereto, and can comprise volatile and/or non-volatile media, and removable and/or non-removable media. In one aspect, the memory 240 can comprise computer-readable media in the form of volatile memory, such as random access memory (RAM), and/or non-volatile memory, such as read-only memory (ROM). As described herein, the memory 240 can be functionally coupled to at least one of the processor(s) 254 and thus, in one aspect, can be referred to as a processor-accessible storage device.

Within the memory 240, the pairing component(s) 258 can be retained within functionality instructions storage (not shown), and the pairing object(s) 244 and the pairing information 248 can be retained within functionality information storage (not shown). The functionality instructions storage can comprise computer-accessible instructions that, in response to execution by at least one of the processor(s) 254, can implement one or more of the pairing functionalities in accordance with aspects of the disclosure. In one scenario, execution of at least one component of the pairing component(s) 736 can implement one or more of the methods described herein. For instance, such execution can cause a processor that executes the at least one component to carry out a disclosed technique. It should be appreciated that, in one aspect, a processor of the processor(s) 254 that executes at least one of the pairing component(s) 736 can retrieve information from and/or convey information to a memory element within the functionality information storage (not shown) in order to operate in accordance with the functionality programmed or otherwise configured by the pairing component(s) 736. Such information can include at least one of programming code instructions (or code instructions), information structures, or the like. At least one of the one or more interfaces 262 (e.g., application programming interface(s)) can permit or otherwise facilitate communication of information between two or more components within the functionality instructions storage. The information that is communicated by the at least one interface can result from implementation of one or more operations in a method in accordance with aspects of the disclosure. In certain embodiments, one or more of the functionality instructions storage and the functionality information storage can be embodied in or can comprise removable/non-removable, and/or volatile/non-volatile computer storage media.

In addition, the memory 240 can comprise computer-accessible instructions and information (e.g., data, metadata, and/or programming code) that permit or facilitate operation and/or administration (e.g., upgrades, software installation, any other configuration, or the like) of the computing device 204. Accordingly, in one aspect, the memory 240 can comprise a memory element (not shown) that can contain one or more program modules that embody or include one or more operating systems, such as a Windows operating system, Unix, Linux, Symbian, Android, Chromium, or substantially any operating system suitable for mobile computing devices or tethered computing devices. In one aspect, the operational and/or architectural complexity of the computing device 204 can dictate a suitable operating system. The memory 240 also can comprise a system information storage (not shown) having data and/or metadata that permits or facilitates operation and/or administration of the computing device 204—e.g., configuration of pairing objects and/or pairing information in accordance with aspects described herein. Elements of the OS instruction(s) and the system information storage can be accessible or can be operated on by at least one of the processor(s) 254.

It should be recognized that while portions of the memory 240 (e.g., component(s) and/or other executable program components, such as the OS instruction(s)), are illustrated herein as discrete blocks, such software components can reside at various times in different memory elements or devices of the computing device 204, and can be executed by at least one of the processor(s) 254. In certain scenarios, an implementation of the pairing component(s) 258 can be retained on or transmitted across some form of computer-readable media.

In certain embodiments, the computing device 204 can include a power supply (not shown), which can power up components or functional elements within such devices. In other embodiments, the computing device 204 can be energized via coupling (direct or indirect) to another device (e.g., service device 130). To at least such an end, in one aspect, the computing device 204 can include suitable circuitry (e.g., transformers) to achieve a power level suitable for operation of the computing device 204. In embodiments in which a power supply is presents, such a power supply can be a rechargeable power supply, e.g., a rechargeable battery, and it can include one or more transformers to achieve a power level suitable for operation of the computing device 204, and components, functional elements, and related circuitry therein. In certain scenarios, the power supply can be attached to a conventional power grid to recharge and ensure that such devices can be operational. In one aspect, the power supply can include an I/O interface (e.g., one of the interface(s) 220) to connect operationally to the conventional power grid. In another aspect, the power supply can include an energy conversion component, such as a solar panel, to provide additional or alternative power resources or autonomy for the computing device 204.

In view of the aspects described herein, examples of techniques for device pairing that can be implemented in accordance with the disclosure can be better appreciated with reference to the diagrams in FIGS. 3-6. For purposes of simplicity of explanation, the examples of the techniques disclosed herein are presented and described as a series of blocks (with each block representing an action or an operation in a method, for example). However, it is to be understood and appreciated that the disclosed techniques (e.g., process(es), procedure(s), method(s), and the like) are not limited by the order of blocks and associated actions or operations, as some blocks may occur in different orders and/or concurrently with other blocks from that are shown and described herein. For example, the various techniques of the disclosure can be alternatively represented as a series of interrelated states or events, such as in a state diagram. Furthermore, not all illustrated blocks, and associated action(s) or operation(s), may be required to implement a technique in accordance with one or more aspects of the disclosure. Further yet, two or more of the disclosed techniques can be implemented in combination with each other, to accomplish one or more features and/or advantages described herein.

It should be appreciated that the techniques of the disclosure can be retained on an article of manufacture, or computer-readable medium, to permit or facilitate transporting and transferring such methods to a computing device for execution, and thus implementation, by a processor of the computing device or for storage in a memory thereof or functionally coupled thereto. In one aspect, one or more processors, such as processor(s) that implement (e.g., execute) one or more of the disclosed techniques, can be employed to execute code instructions retained in a memory, or any computer- or machine-readable medium, to implement the one or more methods. The code instructions can provide a computer-executable or machine-executable framework to implement the techniques described herein.

FIG. 3 presents an example of a process 300 for pairing in accordance with one or more aspects of the disclosure. A computing device having at least one processor or being functionally coupled to at least one processor can implement (e.g., compile, execute, compile and execute, etc.) one or more blocks of the subject illustrative process. The computing device can be or can comprise the wireless adapter device embodied in or constituted by the functional elements in one or more of the illustrative embodiments 200 or 250. In the exemplified process, at block 310, a pairing object or other information structure can be configured. As described herein, in certain implementations, the pairing object can include a unique identifier, such as logical address or a physical address (e.g., a MAC address) and configuring the pairing object can include encoding the unique identifier into the computing device (e.g., a wireless display adapter) that implements at least the block 310.

At block 320, a paring authorization stage can be implemented. At the pairing authorization stage, a pairing request can be evaluated in order to ascertain that the pairing request is authorized or declined. To at least such an end, in one aspect, evaluation of the pairing request can be based at least on comparison of a pairing object or a portion thereof with at least a portion of the ID information contained in the pairing request. Outcome of the comparison can convey or otherwise reveal the authorized or unauthorized nature of the pairing request. In certain scenarios, implementing such a stage can include receiving a request for pairing the computing device that is configured at block 310 with an originating computing device, which can supply (e.g., communicate) the pairing request. The pairing request can include identification (ID) information that is representative of otherwise indicative of the originating computing device. For instance, the pairing request can comprise a unique identifier (e.g., a physical address) which may be referred to as an “originating unique identifier” or a “second unique identifier”). In response to receiving the pairing request, the computing device can determine if the originating unique identifier (e.g., a MAC address) matches the unique identifier that can be contained in the pairing object. In an example scenario in which it is ascertained that the originating local address matches the configured unique identifier (e.g., a logical address or physical address), the pairing request can be authorized or otherwise configured as an authorized pairing request. In the alternative, in example scenarios in which it is ascertained that the originating local address does not match the configured unique identifier, the pairing request can be configured as unauthorized, and thus, it may be declined for further pairing processing. An unauthorized pairing request can lead to implementation of an exception stage (not depicted in FIG. 3) or exception handling. For example, implementation of the exception stage can include implementation of a supplemental authorization stage—e.g., a prompt to input certain security credentials, such as a personal identification number (PIN), can be rendered.

In response to an authorized pairing request, a pairing identification stage can be implemented at block 330. Implementing pairing identification can include communicating ID information indicative or otherwise representative of the computing device that is configured with a pairing object or other pairing information structure. At least a portion of such information can be communicated from the computing device to another computing device (e.g., a personal computer or a tablet computer), and at least the portion of the information can be specific to such a second computing device. It can be appreciated that the ID information can be embody or can comprise a directive to pair or otherwise associate the second computing device with the computing device (e.g., a wireless adapter device). It also can be appreciated that, in one aspect, the second computing device can be or can include equipment that is intended or otherwise desired to be paired with the computing device that contains the pairing object. In addition or in the alternative, implementing the pairing identification can include communicating protocol-support information indicative or otherwise representative of pairing protocol(s) that can be supported for pairing the computing device and the second computing device.

In the illustrative process 300, blocks 310-330 can be collectively referred to as a pre-pairing process 350 that, in at least certain embodiments, can simplify pairing of computing device that can communicate wirelessly. At least a portion of the ID information and/or at least a portion of the protocol-support information that can be communicated (e.g., advertised or otherwise multicasted or broadcasted) at the pairing identification stage can be utilized or otherwise leveraged in order to implement a pairing stage at block 340. In certain embodiments, the ID information can include customized information indicative of an intended relationship between a host device and an adapter device. For instance, the customized information can include a string of characters specifying such relationship: “Host Device_Name-Connect to present adapter.”

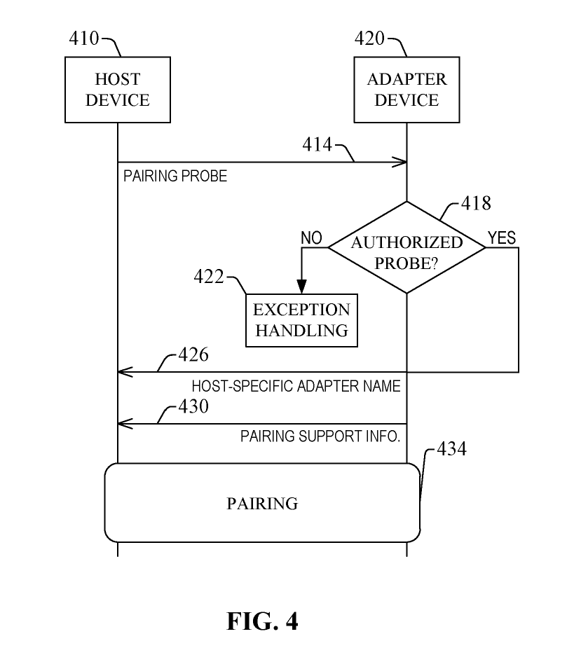

As described herein, the pairing mechanism (e.g., equipment, technique(s), and/or equipment and technique(s)) according with one or more aspects of the disclosure can be leveraged for pairing of wireless computing devices. FIG. 4 illustrates an example of a pairing process 400 in accordance with at least one aspect of the disclosure. In the illustrative subject process, a host device 410 (e.g., a personal computer, or a tablet computer, a smartphone, or the like) can communicate (e.g., transmit) a pairing probe 414 to an adapter device (e.g., a wireless display adapter 420. The pairing probe 414 can be embodied in or can comprise a pairing request including identity information indicative or otherwise representative of the host device 410. As described herein, in one aspect, the pairing probe 414 can include a unique identifier, such as a logical address or a physical address (e.g., a MAC address) of the host device 410. The adapter device 420 is configured with one or more information structures, wherein an information structure of such information structure(s) can be indicative or otherwise representative of an authorized host device that can be permitted to pair or otherwise associate with the adapter device 420. At block 418, the adapter device 420 can determine if the pairing probe 414 is authorized. As described herein, in response to ascertaining that such a probe is authorized, the adapter device 420 can communicate (e.g., transmit) a host-specific adapter name 426 to the host device 410. At least a portion of such information can permit the host device 410 to render a selection option (e.g., indicia representative of such an option) that unique identifies or otherwise presents the adapter device 420 for selection to an end-user of the host device 410. Accordingly, as described herein, the host-specific adapter name 426 can permit distinguishing the adapter device 420 from other adapter device(s) (not depicted) that may not intended for pairing with the host device 410. In addition, in certain embodiments, the adapter device 420 can communicate (e.g., transmit) pairing support information (info.) 430 to the host device 410. At least a portion of such information can include information (e.g., data, metadata, and/or signaling) indicative of a pairing protocol (e.g., a conventional pairing protocol, such as push-button method and/or a credential-based pairing method) that can be available to operationally associate (or pair) the adapter device 420 with the host device 410.

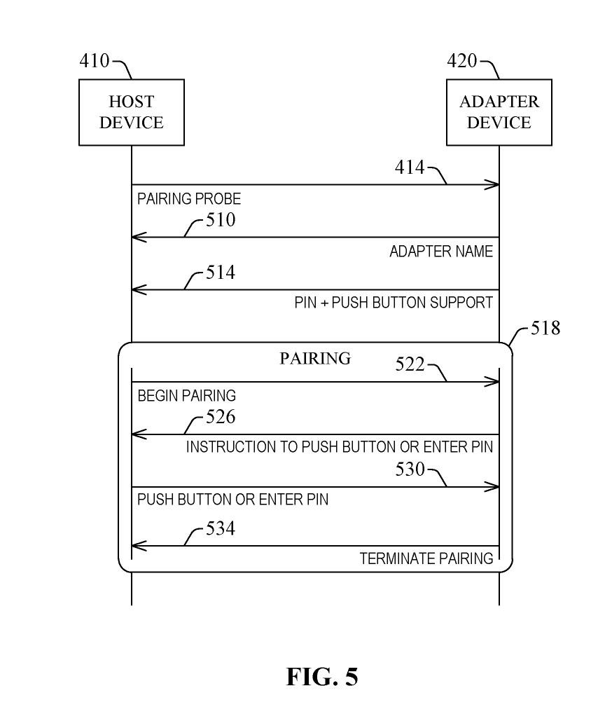

In a scenario in which the pairing probe 414 is ascertained to be unauthorized, the adapter device 420 can perform exception handling at block 422. In one embodiment, exception handling can include implementation of a default or otherwise conventional pairing mechanism, which generally entails end-user intervention. In another embodiment, exception handling can include presentation of pairing instructions to end-user regarding how to proceed with pairing in view of the unauthorized pairing probe. For instance, the following prompt can rendered at a service device (e.g., a display unit) functionally coupled to the adapter device 420: “Please plug this device into the USB port of the intended host device so it can be initialized.” Other prompts or information can be rendered in order to respond to the unauthorized pairing probe. As an illustration of performance of exception handling, FIG. 5 presents an example of a pairing process 500 that can be effected in response to an attempt to pair the adapter device 420 with a non-preconfigured or otherwise unauthorized host device. In one aspect, in response to an unauthorized pairing probe 414, the adapter device 420 can advertise (e.g., broadcast) an adapter name 510, which can be non-unique and/or non-host-specific information indicative or otherwise representative of the adapter device 420. The host device 410 can render at least a portion of the adapter name 510. In addition, the adapter device 420 can communicate (e.g., transmit) information indicative of a default or “exception” pairing protocol that can be utilized or otherwise leveraged by the host device 410 in order to proceed with pairing with the adapter device 420. The host device 410 can acquire (e.g., receive) at least a portion of the information 514 and in response, the host device 410 can communicate signaling information 522 indicative of initiation of pairing according at least to the information 514. The adapter device 420 can receive at least a portion of the information 522 and can communicate an instruction 526 to push a button at the adapter device 420 and/or to enter a credential, such as a personal identification number (PIN), a password, a predetermined string of characters, a combination thereof, or the like. The host device 410 can prompt an end-user according to the instruction 526 in order to cause the end-user to actuate a button configured at the adapter device 420 and/or receive information indicative of the PIN. Although the subject illustrative process is described with reference to a PIN, it can be appreciated that additional or alternative credentials (e.g., a password, a predetermined string of characters, a combination thereof, or the like) can be utilized or otherwise relied on. In addition or in the alternative, the adapter device 420 (via pairing unit as described herein, for example) can cause a service device (e.g., service device 130) coupled thereto to render a code (such as a PIN or other numeric, alphabetic, and or alphanumeric code) in order for an operator of the host device 410 to verify that the adapter device 420 is the device that is desired to be paired. In one aspect, the host device 410 can communicate the credential to the adapter device 420 and/or such a button can be actuated at the adapter device 420. In response, the adapter device 420 can communicate signaling information 534 indicate of termination of the default pairing process.

It can be readily appreciated that, in one aspect, by implementing exception handling, a user device A (e.g., host device 120 A) would be able to pair with their own adapter device without supplying or otherwise entering any special pairing information. Yet, another user device B (e.g., host device B 140) may rely on physical access to the adapter device in order to be able to pair with such adapter.

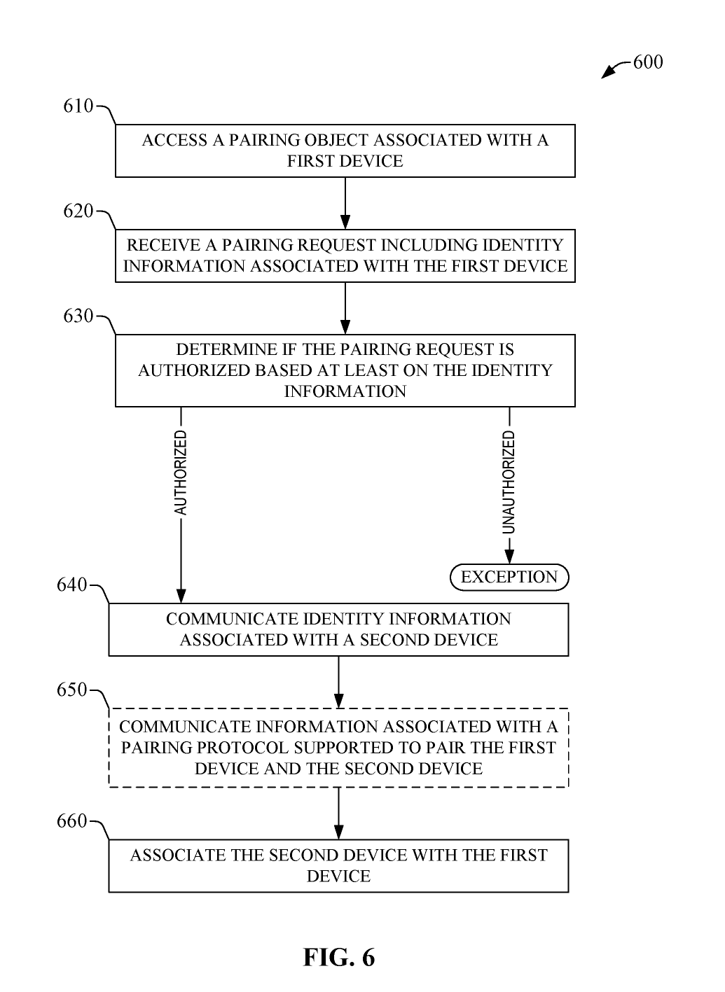

FIG. 6 illustrates an example of a process 600 for pairing computing devices in accordance with at least certain aspects of the disclosure. As described herein, at least one of the computing devices can be embodied in or can comprise a wireless computing device (which also may be referred to as “wireless device”). For instance, in certain embodiments, one of such computing devices can implement one or more blocks of the subject illustrative process. More generally, yet not exclusively, any computing device in accordance with aspects of the disclosure (e.g., a computing device having at least one processor functionally coupled to at least one memory device) can implement one or more blocks of the illustrative process 600. At block 610, a pairing object associated with a first computing device (e.g., a host device) can be accessed. A second computing device (e.g., an adapter device) can access the pairing object. The first computing device and the second computing device can be referred to as first device and second device, respectively. In one aspect, the pairing object can include a unique identifier representative of the first computing device, and accessing such pairing object can include receiving the logical address via encoding of such address into a memory device contained or otherwise coupled to the second computing device. As described herein, the pairing object containing the logical address can be encoded into such a memory device at the time of manufacturing of the first device. In another aspect, accessing the pairing object can include functionally coupling the first computing device to the second computing device via a communication medium (e.g., a USB port and a suitable cable), and supplying the unique identifier to the second computing device via the communication medium. In certain implementations, supplying the unique identifier to the second computing device comprises dynamically encoding the unique identifier into the second computing device.

At block 620, a pairing request including identity information associated with the first device can be received. The second device can receive (e.g., collect, decode, collect and decode, or the like) the pairing request from the first device.

At block 630, it is determined if the pairing request is authorized based at least on the identity information associated with the first device. The second device can effect such determination. In one aspect, as described herein, the identity information can include information indicative or otherwise representative of a unique address, such as a logical address or a physical address (e.g., a MAC address) of the first device. In the illustrated embodiment, in response to ascertaining that the pairing request is unauthorized, an exception can be thrown or otherwise implemented (e.g., example method described in FIG. 5 may be implemented). In the alternative, in a scenario in which the pairing request is authorized, identity information associated with the second device can be communicated at block 640—e.g., the second device can convey at least a portion of such information to the first device (as presented in FIG. 1, for example). In certain embodiments, at optional block 650, information associated with a pairing protocol supported to pair the first device and the second device can be communicated—e.g., the second device can convey at least a portion of such information to the first device (as presented in FIG. 1, for example). In certain operation scenarios, as described herein, communicating the identity information can include transmitting customized identity information indicative of an intended functional coupling between the first device and the second device. In at least one of such scenarios, default identity information associated with the second device (e.g., manufacturer information labeling the second device) can be adjusted to the customized identity information prior to communicating the identity information.

At block 660, the second device can be associated with (e.g., functionally coupled to) the first device. The association can be carried out as part of pairing such devices in accordance with aspects of the disclosure.

Further or alternative example embodiments of the disclosure emerge from the description herein and annexed drawings. In one embodiment, the disclosure provides a method for pairing computing devices. The method can be performed by a computing device (such as a wireless adapter device) having at least one processor functionally coupled to at least one memory device, and can include accessing a pairing object associated with a first computing device. In one implementation, the pairing object can include a unique identifier representative of the first computing device, and accessing such an object can include receiving the logical address via encoding into a memory device of the first computing device. In addition, the method can include receiving a pairing request comprising identity information associated with the first computing device, the pairing request being received from the first computing device and directed to functionally coupling the first computing device and a second computing device. As described herein, the computing device that can perform the method (e.g., execute or otherwise implement the operations of the method) can receive the pairing request. The method also can include determining if the pairing request is authorized based at least on the identity information. The method can further include communicating identity information associated with the second computing device in response to ascertaining that the pairing request is authorized, and associating the first computing device with the second computing device. As described herein, such association operation can permit the first computing device to be functionally paired with the second computing device.

In certain embodiments, accessing the pairing object comprising the unique identifier can include comprises functionally coupling the first computing device to the second computing device via a communication medium, and supplying the unique identifier to the second computing device via the communication medium. In certain implementations, supplying the unique identifier can include dynamically encoding the unique identifier into the second computing device in response to configuring the pairing request at the first computing device.

In an additional or alternative embodiment, the method can further comprise performing exception handling in response to ascertaining that the pairing request is unauthorized. Performing the exception handling can include associating the first computing device to the second computing device according to a default pairing mechanism including end-user intervention. In addition or in the alternative, performing the exception handling can include rendering pairing instructions at the second computing device, the pairing instructions comprising a prompt to input security credentials.

In certain embodiments, the method also can comprise communicating information indicative of a pairing protocol supported to couple the second computing device and the first computing device. Communicating such information can include transmitting (via a pairing unit and/or a radio unit, for example) customized identity information indicative of an intended functional coupling between the first computing device and the second computing device.

In other embodiments, the method can include adjusting or otherwise replacing a default identity information associated with the second computing device to the customized identity information prior to the communicating.

The disclosure is not limited to techniques, and in certain embodiments, the disclosure can provide at least one computer-readable non-transitory storage medium (e.g., memory 240) encoded with computer-accessible instructions (e.g., pairing component(s) 258) that, in response to execution, cause at least one processor (e.g., processor(s) 254) to perform device pairing operations including accessing a pairing object associated with a first computing device. The pairing object can include a unique identifier representative of the first computing device, and wherein the accessing comprises receiving the logical address via encoding into a memory device of the first computing device. In addition, such operations can include receiving a pairing request comprising identity information associated with the first computing device, the pairing request being received from the first computing device and directed to functionally coupling the first computing device and a second computing device. The device pairing operations also can include determining if the pairing request is authorized based at least on the identity information. In response to ascertaining that the pairing request is authorized, the device pairing operations also can include communicating identity information associated with the second computing device, and associating the first computing device with the second computing device.

In certain implementations, accessing a pairing object having a unique identifier can include functionally coupling the first computing device to the second device via a communication medium, and supplying the unique identifier to the second computing device via the communication medium. In one implementation of the pairing operations, supplying the unique identifier to the second computing device can include dynamically encoding the unique identifier into the second computing device in response to configuring the pairing request at the first computing device.

In other embodiments, the device pairing operations encoded in the at least one computer-readable non-transitory storage medium can further comprise communicating information indicative of a pairing protocol supported to couple the second computing device and the first computing device. Communicating such information can include transmitting customized identity information indicative of an intended functional coupling between the first computing device and the second computing device.

In certain embodiments, the pairing operations encoded in the at least one computer-readable non-transitory storage medium also can include performing exception handling in response to ascertaining that the pairing request is unauthorized. In one implementation, performing the exception handling can include associating the first computing device to the second computing device according to a default pairing mechanism including end-user intervention. In another implementation, performing the exception handling can include rendering pairing instructions at the second computing device, for example, where the pairing instructions comprising a prompt to input security credentials.

In other embodiments, the disclosure can provide an apparatus for device pairing. The apparatus can include means for accessing a pairing object associated with a first computing device. As described herein, in one aspect, the pairing object can include a unique identifier representative of the first computing device, and the means for accessing such a pairing object can comprise means for receiving the logical address via encoding into a memory device of the first computing device. In addition, the apparatus can include means for receiving a pairing request comprising identity information associated with the first computing device, the pairing request being received from the first computing device and directed to functionally coupling the first computing device and a second computing device. The apparatus also can include means for determining if the pairing request is authorized based at least on the identity information. Moreover, in response to the pairing request being authorized, the apparatus can include means for communicating identity information associated with the second computing device, and means for associating the first computing device with the second computing device. Further, in response to the pairing request being authorized, the apparatus can include means for communicating information indicative of a pairing protocol supported to couple the second computing device and the first computing device. The means for communicating such information can include means for transmitting customized identity information indicative of an intended functional coupling between the first computing device and the second computing device.

In addition, in response to the pairing request being unauthorized, the apparatus can further include means for performing exception handling. In certain implementations, the means for performing the exception handling can include means for associating the first computing device to the second computing device according to a default pairing mechanism including end-user intervention. In other implementations, the means for performing the exception handling can include means for rendering pairing instructions at the second computing device, the pairing instructions comprising a prompt to input security credentials.

In other embodiments, the pairing object can include a unique identifier representative of the first computing device, and the means for accessing comprises means for functionally coupling the first computing device to the second device via a communication medium, and means for supplying the unique identifier to the second computing device via the communication medium. The means for supplying such a unique identifier can include means for dynamically encoding the unique identifier into the second computing device in response to configuration of the pairing request at the first computing device.

In additional or alternative embodiments, the disclosure provides an apparatus for device pairing, where the apparatus can include a radio configured to receive a pairing request comprising identity information associated with a first computing device. As described herein, the radio (e.g., radio unit 210) can comprise a communication processing unit and a group of antennas. The pairing request can be received from a first computing device and can be directed to functionally coupling the first computing device and a second computing device. The apparatus can further include a pairing unit configured to access a pairing object associated with a first computing device, and further configured to determine if the pairing request is authorized based at least on the identity information. In one aspect, the pairing object can include a unique identifier representative of the first computing device, and wherein the pairing unit is further configured to encode the logical address into a memory device of the first computing device.

In response to the pairing request being authorized, the radio can be further configured to communicate identity information associated with the second computing device, and the pairing unit can be further configured to associate the first computing device with the second computing device. In addition, for an authorized pairing request, the radio can be further configured to communicate information indicative of a pairing protocol supported to couple the second computing device and the first computing device. Moreover, for an authorized pairing request, the radio can be further configured to transmit customized identity information indicative of an intended functional coupling between the first computing device and the second computing device.

In operation scenarios in which the pairing request that is received is ascertained to be unauthorized, the pairing unit can be further configured to perform exception handling. The exception handling can include association of the first computing device with the second computing device according to a default pairing mechanism including end-user intervention. In addition or in the alternative, the exception handling can include presentation of pairing instructions at the second computing device, the pairing instructions comprising a prompt to input security credentials.

In additional or alternative embodiments, the apparatus can include an interface (e.g., one of the interface(s) 220) configured to couple functionally the first computing device to the second device via a communication medium, where the pairing unit of the apparatus can be configured to supply the unique identifier to the second computing device via the communication medium. In addition, in order to supply the unique identifier, for example, the pairing unit can be further configured to encode dynamically the unique identifier into the second computing device in response to configuration of the pairing request at the first computing device.

It should be appreciated that the disclosure is not limited to the apparatuses described herein. In certain embodiments, the disclosure provides a computing device for device pairing, wherein the computing device can include at least one processor-accessible storage device having programmed instructions, and at least one processor configured to execute the programmed instructions. In response to execution of the programmed instructions, the at least one processor can be further configured to receive a pairing request comprising identity information associated with the first computing device, the pairing request being received from a first computing device and directed to functionally coupling the first computing device and a second computing device. In addition, in response to execution of the programmed instructions, the at least one processor can be further configured to access a pairing object associated with the first computing device. The pairing object can include a unique identifier representative of the first computing device, and in response to execution, the at least one processor can be further configured to receive, via encoding, for example, the logical address into a memory device of the first computing device.

Moreover, in response to execution of the programmed instructions, the at least one processor can be further configured to determine if the pairing request is authorized based at least on the identity information. In response to the pairing request being authorized, further in response to execution of the programmed instructions, the at least one processor can communicate identity information associated with the second computing device in response to the pairing request being authorized, and associate the first computing device with the second computing device in accordance with at least certain aspects described herein.

In one embodiment of the computing device, in response to execution, the at least one processor can be further configured to communicate information indicative of a pairing protocol supported to couple the second computing device and the first computing device. In addition or in the alternative, in response to execution, the at least one processor can be further configured to communicate customized identity information indicative of an intended functional coupling between the first computing device and the second computing device. Moreover, in response to execution, the at least one processor can be further configured to adjust a default identity information associated with the second computing device to the customized identity information prior to the communicating.

In response to the pairing request that is received at the computing device, in response to execution of the programmed instructions, the at least one processor can be further configured to perform exception handling. In certain implementations, the exception handling can include association of the first computing device with the second computing device according to a default pairing mechanism including end-user intervention. In other implementations, the exception handling can include presentation of pairing instructions at the second computing device, the pairing instructions comprising a prompt to input security credentials.

As described herein, a pairing object can be supplied or otherwise provided dynamically. In certain embodiments of the computing device, in response to execution of the programmed instructions, the at least one processor can be further configured to couple functionally the first computing device to the second device via a communication medium, and to supply the unique identifier to the second computing device via the communication medium. In such embodiments, in response to execution of the programmed instructions, the at least one processor is further configured to encode dynamically the unique identifier into the second computing device in response to configuration of the pairing request at the first computing device.

The disclosure provides other embodiments for device pairing in accordance with the disclosure. For example the disclosure provides at least one processor-accessible storage device having programmed instructions for device pairing that, in response to execution, cause at least one processor to perform any of the methods described or otherwise conveyed herein. For another example, the disclosure provides at least one processor-accessible storage device having programmed instructions for device pairing that, in response to execution, can cause at least one processor to perform a method or realize an apparatus as described herein. For yet another example, the disclosure can provide an apparatus that can include means for performing one or more of the methods described or otherwise conveyed herein. For still another example, the disclosure provides a computing device for device pairing, where such a computing device can comprise a radio configured to exchange information with a wireless computing device; and a pairing unit functionally coupled to the radio, where the computing device can be arranged to perform any of the methods described or otherwise conveyed herein.

Several advantages over conventional technologies for pairing of wireless devices emerge from the present specification and annexed drawings. One example advantage may include simplification of end-user intervention related to associating a wireless device to a host device, including mitigation or avoidance of reliance on end-user credentials and/or user-interaction (such as pressing a button) for implementation of device pairing. Another example advantage may include reduction or avoidance of pairing inaccuracies that may lead to troubleshooting difficulties or non-operational pairing configurations.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and techniques (procedures, methods, processes, and the like) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into onto a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “environment,” “system,” “architecture,” “interface,” “unit,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or other programming components. The terms “component,” “environment,” “system,” “architecture,” “interface,” “unit,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. A processor can be implemented as a combination of computing processing units. In certain embodiments, processors can utilize nanoscale architectures such as, but not limited to, molecular and quantum-dot based transistors, switches and gates, in order to optimize space usage or enhance performance of user equipment.

In addition, in the present specification and annexed drawings, terms such as “store,” “storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer-program products that can provide pairing between devices, such as wireless computing devices. It is, of course, not possible to describe every conceivable combination of elements and/or methods for purposes of describing the various features of the disclosure, but it can be recognize that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

What is claimed is:

1. At least one computer-readable non-transitory storage medium encoded with computer-accessible instructions that, in response to execution, cause at least one processor to perform device pairing operations comprising:
accessing a pairing object associated with a first computing device;
receiving a pairing request comprising identity information associated with the first computing device, the pairing request being received from the first computing device and directed to functionally coupling the first computing device and a second computing device;
determining if the pairing request is authorized based at least on the identity information; and
communicating identity information associated with the second computing device in response to ascertaining that the pairing request is authorized, and
associating the first computing device with the second computing device.

2. The at least one computer-readable non-transitory storage medium of claim 1, wherein further in response to ascertaining that the pairing request is authorized, the device pairing operations further comprise communicating information indicative of a pairing protocol supported to couple the second computing device and the first computing device.

3. The at least one computer-readable non-transitory storage medium of claim 1, wherein the communicating comprises transmitting customized identity information indicative of an intended functional coupling between the first computing device and the second computing device.

4. The at least one computer-readable non-transitory storage medium of claim 1, wherein the pairing object comprises a unique identifier representative of the first computing device, and wherein the accessing comprises receiving the logical address via encoding into a memory device of the first computing device.

5. The at least one computer-readable non-transitory storage medium of claim 1, wherein the pairing object comprises a unique identifier representative of the first computing device, and wherein the accessing comprises functionally coupling the first computing device to the second device via a communication medium, and
supplying the unique identifier to the second computing device via the communication medium.

6. The at least one computer-readable non-transitory storage medium of claim 5, wherein the supplying comprises dynamically encoding the unique identifier into the second computing device in response to configuring the pairing request at the first computing device.

7. The at least one computer-readable non-transitory storage medium of claim 1, further comprising performing exception handling in response to ascertaining that the pairing request is unauthorized, wherein the performing comprises associating the first computing device with the second computing device according to a default pairing mechanism including end-user intervention.

8. The at least one computer-readable non-transitory storage medium of claim 1, further comprising performing exception handling in response to ascertaining that the pairing request is unauthorized, wherein the performing comprises rendering pairing instructions at the second computing device, the pairing instructions comprising a prompt to input security credentials.

9. An apparatus for device pairing, comprising:
means for accessing a pairing object associated with a first computing device;
means for receiving a pairing request comprising identity information associated with the first computing device, the pairing request being received from the first computing device and directed to functionally coupling the first computing device and a second computing device;
means for determining if the pairing request is authorized based at least on the identity information;
means for communicating identity information associated with the second computing device in response to the pairing request being authorized; and
means for associating the first computing device to the second computing device.

10. The apparatus of claim 9, wherein further in response to the pairing request being authorized, the apparatus further comprises means for communicating information indicative of a pairing protocol supported to couple the second computing device and the first computing device.

11. The apparatus of claim 9, wherein the means for communicating comprises means for transmitting customized identity information indicative of an intended functional coupling between the first computing device and the second computing device.

12. The apparatus of claim 9, wherein the pairing object comprises a unique identifier representative of the first computing device, and wherein the means for accessing comprises means for receiving the logical address via encoding into a memory device of the first computing device.

13. The apparatus of claim 9, wherein the pairing object comprises a unique identifier representative of the first computing device, and wherein the means for accessing comprises means for functionally coupling the first computing device to the second device via a communication medium, and
means for supplying the unique identifier to the second computing device via the communication medium.

14. The apparatus of claim 13, wherein the means for supplying comprises means for dynamically encoding the unique identifier into the second computing device in response to configuration of the pairing request at the first computing device.

15. The apparatus of claim 9, further comprising means for performing exception handling in response to the pairing request being unauthorized, wherein the means for performing the exception handling comprises means for associating the first computing device with the second computing device according to a default pairing mechanism including end-user intervention.

16. The apparatus of claim 9, further comprising means for performing exception handling in response to the pairing request being unauthorized, wherein the means for performing the exception handling comprises means for rendering pairing instructions at the second computing device, the pairing instructions comprising a prompt to input security credentials.

17. An apparatus for device pairing, comprising:
a radio configured to receive a pairing request comprising identity information associated with a first computing device, the pairing request being received from a first computing device and directed to functionally coupling the first computing device and a second computing device, wherein the radio comprises a communication processing unit and a group of antennas; and
a pairing unit configured to access a pairing object associated with a first computing device, and further configured to determine if the pairing request is authorized based at least on the identity information;
in response to the pairing request being authorized, the radio being further configured to communicate identity information associated with the second computing device, and
the pairing unit being further configured to associate the first computing device with the second computing device.

18. The apparatus of claim 17, wherein further in response to the pairing request being authorized, the radio is further configured to communicate information indicative of a pairing protocol supported to couple the second computing device and the first computing device.

19. The apparatus of claim 18, wherein the radio is further configured to transmit customized identity information indicative of an intended functional coupling between the first computing device and the second computing device.

20. The apparatus of claim 17, wherein the pairing object comprises a unique identifier representative of the first computing device, and wherein the pairing unit is further configured to encode the logical address into a memory device of the first computing device.

21. The apparatus of claim 17, wherein the pairing object comprises a unique identifier representative of the first computing device, and further comprising an interface configured to couple functionally the first computing device to the second device via a communication medium,
wherein the pairing unit is configured to supply the unique identifier to the second computing device via the communication medium.

22. The apparatus of claim 17, wherein the pairing unit is further configured to encode dynamically the unique identifier into the second computing device in response to configuration of the pairing request at the first computing device.

23. The apparatus of claim 17, wherein the pairing unit is further configured to perform exception handling in response to the pairing request being unauthorized, wherein the exception handling comprises association of the first computing device with the second computing device according to a default pairing mechanism including end-user intervention.

24. The apparatus of claim 17, wherein the pairing unit is further configured to perform exception handling in response to the pairing request being unauthorized, wherein the exception handling comprises presentation of pairing instructions at the second computing device, the pairing instructions comprising a prompt to input security credentials.
